(19) United States
(12) Patent Application Publication
(10) Pub. No.: US 2005/0108206 A1
(43) Pub. Date: May 19, 2005

(54) System and method for object-oriented interaction with heterogeneous data stores

(75) Inventors: Hiu-Ming Eric Lam, Bellevue, WA (US); Mark McCasey, Seattle, WA (US); Sivaprasad Padisetty, Redmond, WA (US); Venkata S. Remany, Redmond, WA (US)

Correspondence Address: LEYDIG, VOIT & MAYER, LTD., TWO PRUDENTIAL PLAZA, SUITE 4900, 180 NORTH STETSON, CHICAGO, IL, 60601-6780, US

(73) Assignee: Microsoft Corporation, Redmond, WA (US)

(21) Appl. No.: 10/713,712

(22) Filed: Nov. 14, 2003

(51) Int. Cl. G06F 17/30

(52) U.S. Cl. 707/3

(57) ABSTRACT

Modern enterprises have multiple dissimilar data stores. Collectively, the enterprise data stores store a set of enterprise data objects, typically in multiple dissimilar formats. An object-oriented heterogeneous data store interface (HDSI) for interacting with such enterprise data stores and data objects is described. The HDSI may include a query component, a data store component and a provider interface that specifies a query behavior with a query component parameter. For each type of data store, there may be a provider plug-in to the HDSI. Each provider plug-in may include provider components that conform to the provider interface. The HDSI may further include data store object components corresponding to data objects stored in the data stores. A data store object design GUI may be utilized to build graphical representations of data objects. A data store object source code generator may generate object-oriented programming language source code for each data store object component.

### FIELD OF THE INVENTION

This invention pertains generally to computer systems, and, more particularly, to interaction with data stores in computer systems.

### BACKGROUND OF THE INVENTION

Modern computer systems, particularly networked computer systems, may include multiple dissimilar stores of data (data stores). The ability to interact with heterogeneous data stores is a desirable ability for numerous computer system applications. However, each type of data store may have its own interface that is different from each of the others. As a result, even elementary operations such as copying a particular data object from one type of data store to another may require a significant effort on the part of an application implementer.

Heterogeneous computer system environments may arise over time or by design, but typically they make provision for further change. New types of data store may become available. Existing data store types may be retired. One way for a computer systems designer to make provision for changing heterogeneous environments is to utilize computer system design techniques centered around data objects, that is, to utilize object-oriented design techniques. However, many data stores are not object-oriented. As a result, an additional custom translation module, for example, may be required for each data store.

Some conventional systems for interacting with heterogeneous data stores are not object-oriented. As a result, they may offer little improvement over a non-object-oriented data store from the point of view of an object-oriented application. Some conventional systems for interacting with multiple dissimilar data stores are nominally object-oriented but do not provide an object-oriented method for querying the data stores, or do not provide the ability to treat queries themselves as data objects. Some conventional systems may require the computer systems designer, when working with non-object-oriented data stores, to manually change the structure of data within the non-object-oriented data stores when the object-oriented design is changed. Such requirements may also undermine the benefits of utilizing object-oriented design techniques.

### BRIEF SUMMARY OF THE INVENTION

This section presents a simplified summary of some embodiments of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In an embodiment of the invention, there may be one or more data stores, each of a different type, that store one or more data objects. Further, there may be an object-oriented heterogeneous data store interface for interacting with the data stores. The object-oriented heterogeneous data store interface may include a query component and a provider interface that specifies a query behavior with a query component parameter for provider components. For each type of data store, there may be a provider plug-in to the object-oriented heterogeneous data store interface. Each provider plug-in may include one or more provider components that conform to the provider interface.

In an embodiment of the invention, the query component of the object-oriented heterogeneous data store interface may be instantiated. Each query component may have an add expression behavior with at least one query term parameter and a query operator parameter. A query expression may be added to the instantiated query component with the add expression behavior of the query component. The query component may be provided to a data store component of the object-oriented heterogeneous data store interface.

In an embodiment of the invention, the object-oriented heterogeneous data store interface may include one or more data store object components corresponding to data objects stored in the data stores. A data store object design graphical user interface (GUI) may be utilized to build graphical representations of data objects. A data store object source code generator may generate object-oriented programming language source code for each data store object component of the object-oriented heterogeneous data store interface.

### BRIEF DESCRIPTION OF THE DRAWINGS

While the appended claims set forth the features of the invention with particularity, the invention and its advantages are best understood from the following detailed description taken in conjunction with the accompanying drawings, of which:

FIG. 1 is a schematic diagram generally illustrating an exemplary computer system usable to implement an embodiment of the invention;

FIG. 2 is a schematic diagram illustrating an example high level modular software architecture in accordance with an embodiment of the invention;

FIG. 3 is a schematic diagram illustrating an example modular data store object generation architecture in accordance with an embodiment of the invention;

FIG. 4A is a schematic diagram depicting example relationships between heterogeneous data store interface components in accordance with an embodiment of the invention;

FIG. 4B is a schematic diagram depicting further example relationships between heterogeneous data store interface components in accordance with an embodiment of the invention;

FIG. 5 is a schematic diagram depicting example relationships between heterogeneous data store interface and provider plug-in components in accordance with an embodiment of the invention;

FIG. 6 is a block diagram depicting example details of an heterogeneous data store interface enterprise component in accordance with an embodiment of the invention;

FIG. 7 is a block diagram depicting example details of an heterogeneous data store interface data store component in accordance with an embodiment of the invention;

FIG. 8 is a block diagram depicting example details of an heterogeneous data store interface data store object component in accordance with an embodiment of the invention;

FIG. 9 is a block diagram depicting example details of an heterogeneous data store interface query component in accordance with an embodiment of the invention;

FIG. 10 is a block diagram depicting example details of a provider object interface in accordance with an embodiment of the invention;

FIG. 11 is a block diagram depicting example details of a provider interface in accordance with an embodiment of the invention;

FIG. 12 is a flowchart depicting example steps that may be performed to generate data store object components for the heterogeneous data store interface in accordance with an embodiment of the invention;

FIG. 13 is a flowchart depicting example steps that may be performed to configure the query component of the heterogeneous data store interface in accordance with an embodiment of the invention;

FIG. 14 is a flowchart depicting example steps incorporating query expression grouping that may be performed to configure the query component of the heterogeneous data store interface in accordance with an embodiment of the invention;

FIG. 15 is a flowchart depicting example steps incorporating query component nesting that may be performed to configure the query component of the heterogeneous data store interface in accordance with an embodiment of the invention; and

FIG. 16 is a flowchart depicting example steps that may be performed by the data store object component in accordance with an embodiment of the invention.

### DETAILED DESCRIPTION OF THE INVENTION

Prior to proceeding with a description of the various embodiments of the invention, a description of a computer in which the various embodiments of the invention may be practiced is now provided. Although not required, the invention will be described in the general context of computer-executable instructions, such as program modules, being executed by a computer. Generally, programs include routines, objects, components, data structures and the like that perform particular tasks or implement particular abstract data types. The term “program” as used herein may connote a single program module or multiple program modules acting in concert. The terms “computer” and “computing device” as used herein include any device that electronically executes one or more programs, such as personal computers (PCs), hand-held devices, multi-processor systems, microprocessor-based programmable consumer electronics, network PCs, minicomputers, tablet PCs, laptop computers, consumer appliances having a microprocessor or microcontroller, routers, gateways, hubs and the like. The invention may also be employed in distributed computing environments, where tasks are performed by remote processing devices that are linked through a communications network. In a distributed computing environment, programs may be located in both local and remote memory storage devices.

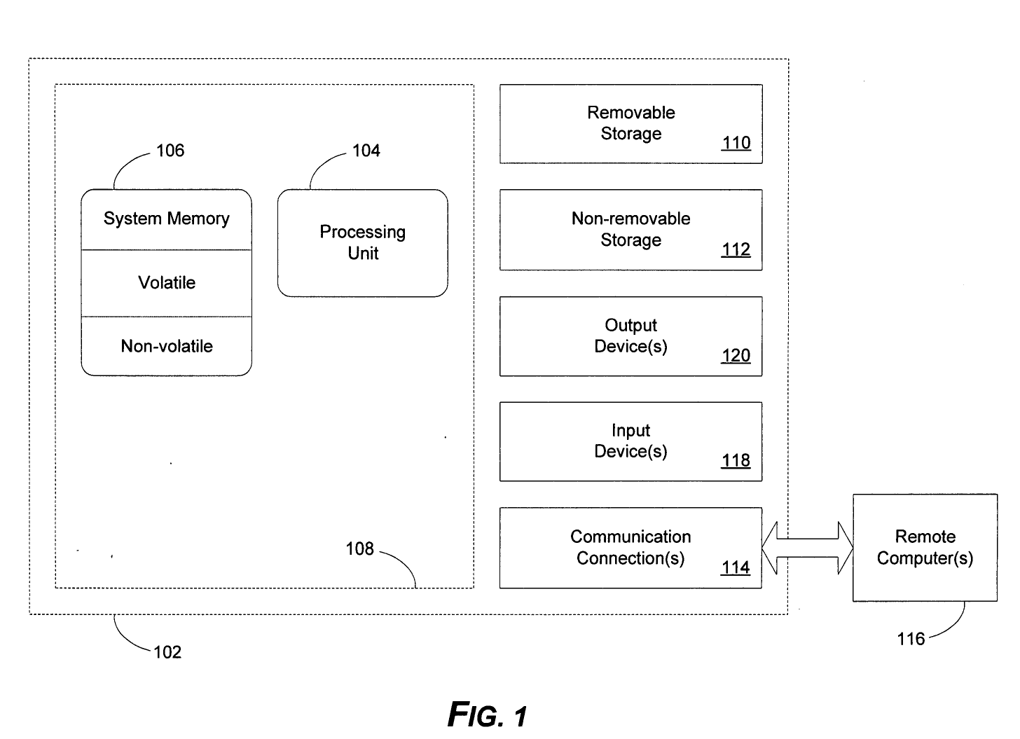

Referring to FIG. 1, an example of a basic configuration for the computer 102 on which aspects of the invention described herein may be implemented is shown. In its most basic configuration, the computer 102 typically includes at least one processing unit 104 and memory 106. The processing unit 104 executes instructions to carry out tasks in accordance with various embodiments of the invention. In carrying out such tasks, the processing unit 104 may transmit electronic signals to other parts of the computer 102 and to devices outside of the computer 102 to cause some result. Depending on the exact configuration and type of the computer 102, the memory 106 may be volatile (such as RAM), non-volatile (such as ROM or flash memory) or some combination of the two. This most basic configuration is illustrated in FIG. 1 by dashed line 108.

The computer 102 may also have additional features/functionality. For example, computer 102 may also include additional storage (removable 110 and/or non-removable 112) including, but not limited to, magnetic or optical disks or tape. Computer storage media includes volatile and non-volatile, removable and non-removable media implemented in any method or technology for storage of information, including computer-executable instructions, data structures, program modules, or other data. Computer storage media includes, but is not limited to, RAM, ROM, EEPROM, flash memory, CD-ROM, digital versatile disk (DVD) or other optical storage, magnetic cassettes, magnetic tape, magnetic disk storage or other magnetic storage devices, or any other medium which can be used to stored the desired information and which can be accessed by the computer 102. Any such computer storage media may be part of computer 102.

The computer 102 preferably also contains communications connections 114 that allow the device to communicate with other devices such as remote computer(s) 116. A communication connection is an example of a communication medium. Communication media typically embody computer readable instructions, data structures, program modules or other data in a modulated data signal such as a carrier wave or other transport mechanism and includes any information delivery media. By way of example, and not limitation, the term “communication media” includes wireless media such as acoustic, RF, infrared and other wireless media. The term “computer-readable medium” as used herein includes both computer storage media and communication media.

The computer 102 may also have input devices 118 such as a keyboard/keypad, mouse, pen, voice input device, touch input device, etc. Output devices 120 such as a display, speakers, a printer, etc. may also be included. All these devices are well known in the art and need not be described at length here.

In the description that follows, the invention will be described with reference to acts and symbolic representations of operations that are performed by one or more computing devices, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operation described hereinafter may also be implemented in hardware.

A modern enterprise may have its data stored in several data stores, each of which may be of a different type. For example, some data may be stored as flat data files on a UNIX® or Microsoft® Windows® file system, some data may be stored in tables managed by a relational database management system (RDBMS), other data may be managed by an XML server and further data may be managed by a custom application with a custom object-oriented application programming interface (API). While each data store may be maintained by a different aspect or department of the enterprise, it is common for the enterprise to develop applications that interact with multiple data stores within the enterprise, as well as data stores in other enterprises and even public data stores.

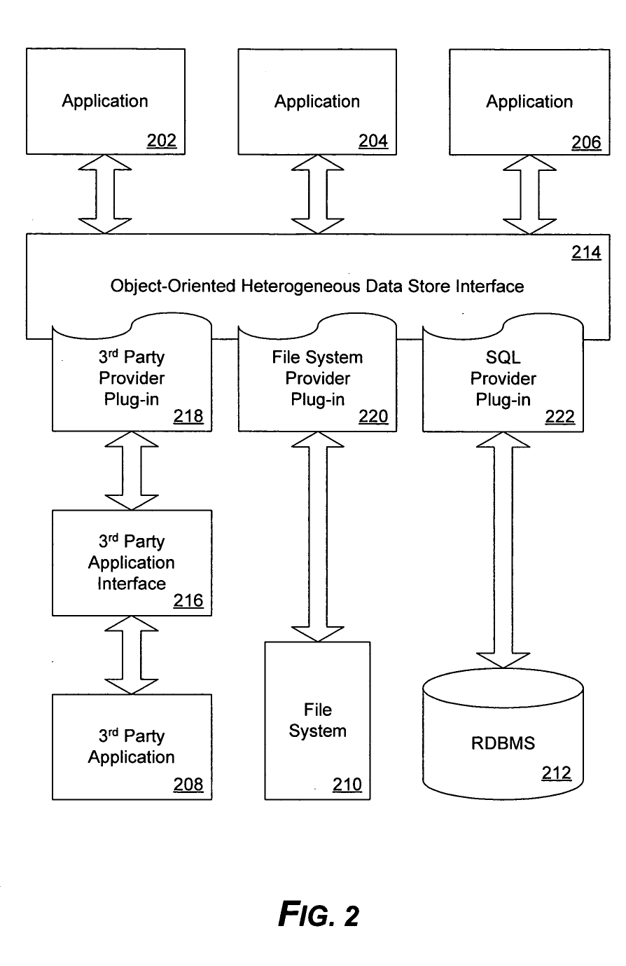

It has become common to design and implement such applications with object-oriented techniques. In an embodiment of the invention, a single object-oriented application programming interface (API) enables applications to interact with multiple, potentially dissimilar, data stores. FIG. 2 illustrates an example high level modular software architecture in accordance with an embodiment of the invention.

In FIG. 2, multiple applications 202, 204, 206 interact with multiple dissimilar data stores 208, 210, 212 through a single object-oriented heterogeneous data store interface (HDSI) 214. The example data stores shown in FIG. 2 are: a 3^{rd} party application 208 (i.e., an application designed by a party other than the enterprise or a vendor of an embodiment of the invention), a file system 210 and a relational database management system (RDBMS) 212. File systems and relational database management systems are well known in the art. The 3^{rd} party application 208 may be a security application, a network monitoring application, an operations application, or any suitable 3^{rd} party application. The 3^{rd} party application 208 has a 3^{rd} party application interface 216 that allows interaction with data managed by the 3^{rd} party application 208. In this example, the 3^{rd} party application interface 216 is an object-oriented application programming interface (API). Although not shown explicitly in FIG. 2, each data store 208, 210, 212 may have an associated application programming interface, not necessarily object-oriented.

Each data store 208, 210, 212 has an associated provider plug-in 218, 220, 222. The 3^{rd} party application 208 has an associated 3^{rd} party provider plug-in 218 that interacts with the 3^{rd} party application 208 through the 3^{rd} party application interface 216. The file system 210 has a file system provider plug-in 220. The relational database management system 212 has an associated structured query language (SQL) provider plug-in 222. Each provider plug-in 218, 220, 222 conforms to a provider plug-in object-oriented application programming interface which is described in more detail below.

The heterogeneous data store interface 214 may provide data store objects (DSO) to each application 202, 204, 206 in a form native to the object-oriented programming language of the application, for example, as an instance of a C++, C# or Java data store object class. Data objects stored in data stores may not be in the form native to the object-oriented programming language of the application. As a result, the form of the data object native to the object-oriented programming language may need to be described in the object-oriented programming language. In an embodiment of the invention, the form of the data object native to the object-oriented programming language may be automatically generated from a graphical representation of the data object.

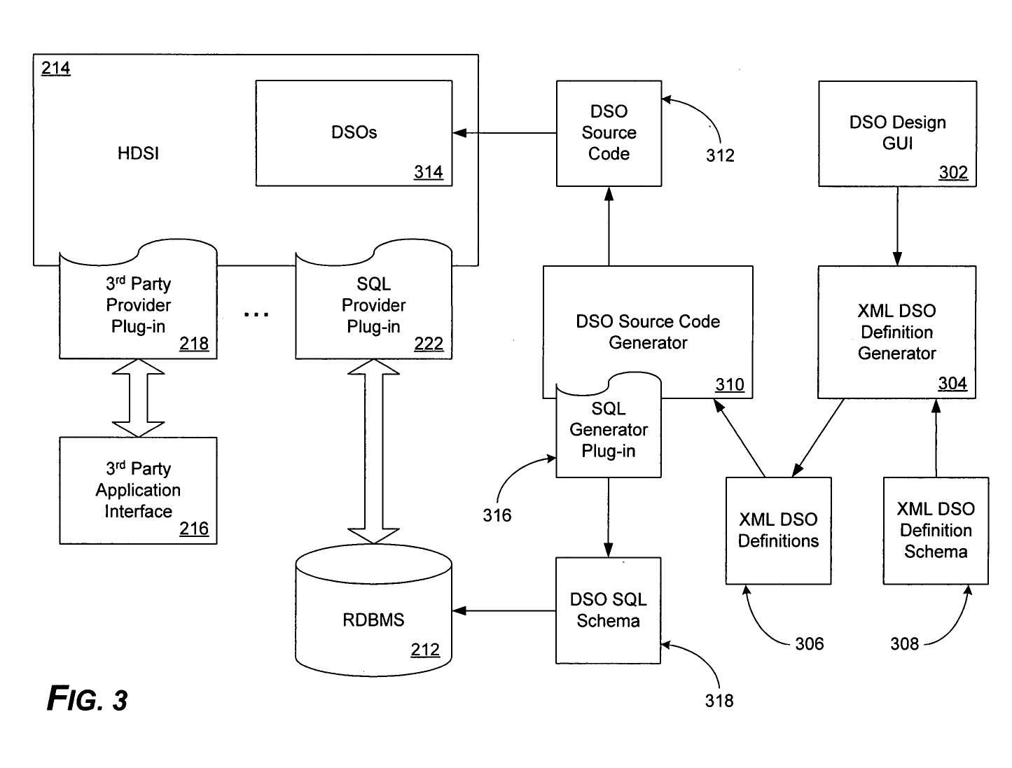

FIG. 3 illustrates an example modular data store object (DSO) generation architecture in accordance with an embodiment of the invention. A data store object (DSO) design graphical user interface (GUI) 302 enables a computer system user to build one or more graphical representations of data objects with a graphical user interface. An extensible markup language (XML) data store object (DSO) definition generator 304 generates extensible markup language (XML) data store object (DSO) definitions 306 from the graphical representations of data objects in accordance with an extensible markup language (XML) data store object (DSO) definition schema 308. A data store object (DSO) source code generator 310 generates data store object (DSO) source code 312 from the extensible markup language data store object definitions 306.

The data store object source code 312 may be a description of one or more data store objects in one or more object-oriented programming languages. The data store object source code 312 may be compiled into computer-executable data store object components 314 with an object-oriented programming language complier. The heterogeneous data store interface 214 may provide data store objects to applications (not shown in FIG. 3) in a form native to the object-oriented programming language of the application from the data store object components 314. For example, the data store object source code 312 may describe C# data store object classes, the data store object components 314 may be compiled representations of those classes and the heterogeneous data store interface 214 may provide instances of those classes to applications.

The form of data objects stored in data stores may differ from the form of the data store object components 314. In an embodiment of the invention, a function of the provider plug-ins is to map data objects stored in data stores to data store object components 314 and vice versa. For example, the 3^{rd} party provider plug-in 218 may map attributes of data objects provided by the 3^{rd} party application interface 216 to attributes of data store object components 314.

A provider plug-in for a relational data store may implement a mapping algorithm that maps each data store object component 314 to and from the relational data store. For example, each data store object component 314 may map to one or more tables in a relational database, and each data store object component 314 attribute may map to a field with the same name as the attribute (with a standard procedure for resolving collisions) in the relational database tables or to further data store object components 314. A provider plug-in with such a mapping algorithm may enable the automatic generation of relational data structures for storing data objects corresponding to data store object components 314 in the relational data store.

In an embodiment of the invention, each provider plug-in for a particular data store may have a corresponding data store object source code generator plug-in for generating data store data objects corresponding to data store object components 314. For example, in FIG. 3, the structured query language (SQL) provider plug-in 222 has a corresponding structured query language (SQL) generator plug-in 316. The data store object source code generator 310 may generate data store object (DSO) structured query language (SQL) schema 318 statements suitable for creating relational data structures with the structured query language generator plug-in 316. The data store object structured query language schema 318 and the data store object source code 312 may be generated from the same extensible markup language data store object definitions 306.

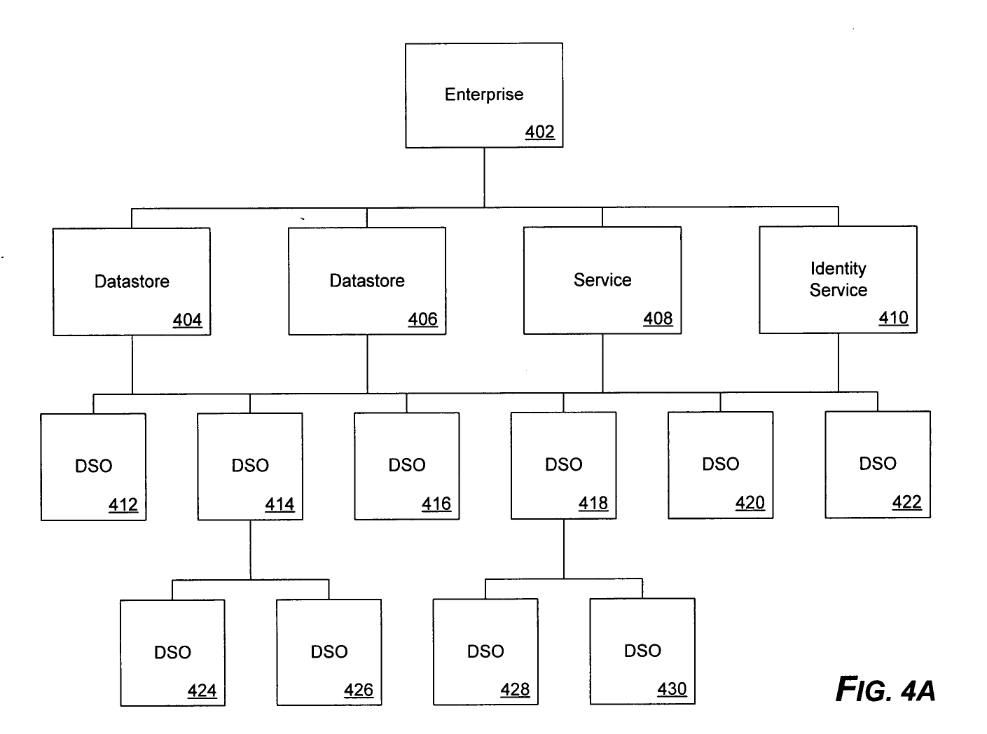

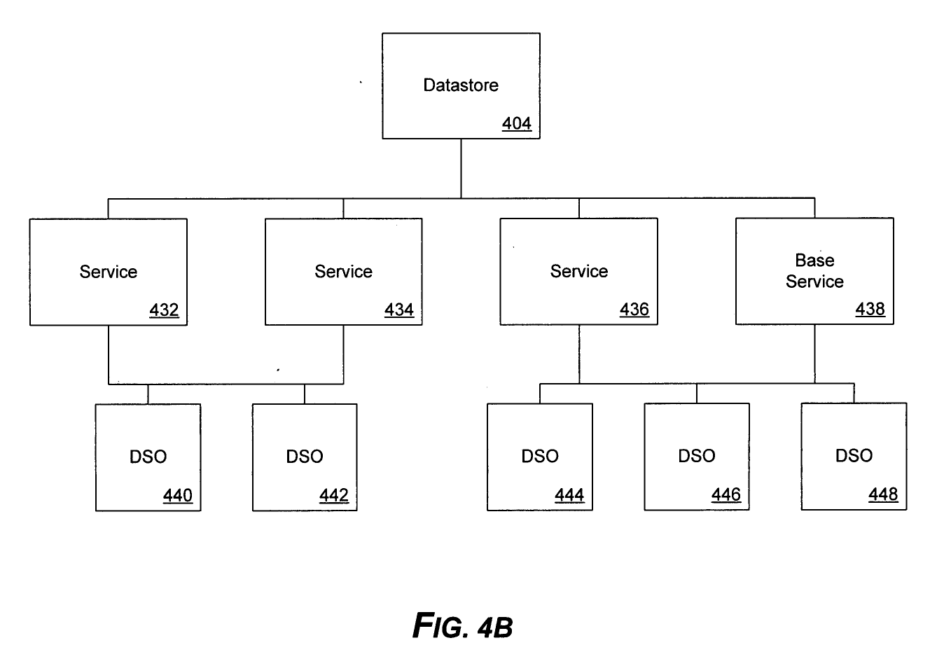

Before describing procedures performed by modules and components of FIG. 2 and FIG. 3 in more detail, it will be helpful to further describe aspects of the heterogeneous data store interface 214 (FIG. 2) and the heterogeneous data store interface provider plug-ins 218, 220, 222. In addition to data store object components 314 (FIG. 3), the heterogeneous data store interface 214 may include one or more enterprise components, one or more data store components and one or more service components. FIG. 4A and FIG. 4B depict example relationships between heterogeneous data store interface components in accordance with an embodiment of the invention.

An enterprise component 402 (FIG. 4A) manages enterprise-level aspects of heterogeneous data store interaction. Each enterprise component may have reference to one or more data store components. The enterprise component 402 has reference to data store component 404 and data store component 406. Each enterprise component may have reference to one or more service components. The enterprise component 402 has reference to service component 408 and service component 410.

The service component 410 is an identity service component. The identity service component 410 may include a directory of each data store component 404, 406 and other service components 408 referenced by the enterprise component 402. The identity service component 410 may be a mechanism by which the enterprise component 402 references data store components 404, 406 and other service components 408. The extent of the enterprise associated with the enterprise component 402 may be delimited by the directory maintained by one or more identity service components 410 referenced by the enterprise component 402.

Each data store component 404, 406 may correspond to one of the data stores of the enterprise (i.e., an enterprise data store). Each data store component may have reference to one or more data store object components (DSO). For example, in FIG. 4A, the data store component 404 and the data store component 406 each have reference to data store object component 412, 414, 416, 418, 420, 422, 424, 426, 428 and 430. In an embodiment of the invention, data store components are capable, in the corresponding enterprise data store, of creating, reading, updating and deleting each data store object component referenced by the data store component. An association between a particular data store object component and a particular data store component may designate a physical location of the data object associated with the data store object component. For example, the data object associated with the data store object component 412 may be physically located in the enterprise data store associated with the data store component 404.

Each service component 408, 410 may correspond to a data providing service of the enterprise (i.e., an enterprise service). Each service component may have reference to one or more data store object components (DSO). For example, in FIG. 4A, the service component 408 and the service component 410 each have reference to data store object components 412, 414, 416, 418, 420, 422, 424, 426, 428 and 430. In an embodiment of the invention, service components are capable, at least, of reading each data store object component referenced by the service component from the corresponding data providing service of the enterprise.

FIG. 4B illustrates that each data store component may also have reference to one or more service components. In FIG. 4B, the data store component 404 has reference to service components 432, 434, 436 and 438. The data store object components referenced by the service component may form a set of logically related data store object components. For example, data store object components (DSO) 440 and 442 may be logically related to service component 432, and data store object components 444, 446 and 448 may be logically related to service component 436.

The enterprise service associated with the service component 438 is a base service. The base service component 438 may provide basic heterogeneous data store interface 214 (FIG. 2) services to the data store component 404. Each data store component 404, 406 may have reference to, at least, the base service component 438. Additional enterprise service types include a replication service, a purging service and custom user services.

Service components 432, 434, 436, 438 may depend upon other service components 432, 434, 436, 438. For example, each service component 432, 434, 436 may depend upon the base service component 438. Service components 432, 434, 436, 438 may be versioned. The enterprise component 402 (FIG. 4A) may enforce service component dependencies and may dynamically attempt to resolve missing dependencies (e.g., load missing service components). The enterprise component 402 may unload unneeded service components 432, 434, 436, 438. In addition, the enterprise component 402 may be informed of (or query for) service component updates, for example, at the time a connection to an enterprise data store is established, and, as a result, load those updates.

Referring to FIG. 4A and FIG. 4B, a security policy may be enforced by enterprise components 402, data store components 404, 406, service components 408, 410, 432, 434, 436 and 438, and data store object components 412, 414, 416, 418, 420, 422, 424, 426, 428, 430, 440, 442, 444, 446 and 448. For example, component attribute and behavior access permissions may be assigned to groups of data store users (i.e., to a user group) and if a data store user in the user group has insufficient access permissions to access a particular component attribute or behavior then the component may deny access and indicate a security policy violation (e.g., throw a security policy violation exception). The heterogeneous data store interface 214 (FIG. 2) may include secured and unsecured components, that is, components that enforce security policy and components that do not enforce security policy. The data store object design graphical user interface 302 (FIG. 3) may include an ability to designate secured data store object components as well as to associated a particular security policy with each secured data store object component.

User groups and access permissions may be associated with each level of the hierarchies depicted in FIG. 4A and FIG. 4B. There may be enterprise level user groups and access permissions, data store level user groups and access permissions, service level user groups and access permissions and data store object level user groups and access permissions. Data store object component hierarchies may also have associated user groups and access permissions. In FIG. 4A, parent data store object component 414 references two child data store object components 424 and 426, and parent data store object component 418 references two child data store object components 428 and 430. Child components in a hierarchy may inherit the access permissions of their parent components and/or have independent associated access permissions.

User groups may include enterprise administrators, data store administrators and data store users. Each enterprise administrator group may be associated with a particular enterprise component (e.g., the enterprise component 402). Members of the enterprise administrator group may have full access permissions for each component 402, 404, 406, 408, 410, 412, 414, 416, 418, 420, 422, 424, 426, 428, 430, 432, 434, 436, 438, 440, 442, 444, 446 and 448, the ability to grant, view, change and remove access permissions for each data store user as well as the ability to add and/or remove each data store user from each user group at or below the enterprise administrator group in the hierarchy associated with the enterprise component 402 (e.g., data store administrator groups associated with data store components referenced by the enterprise component).

Each data store administrator group may be associated with a particular data store component (e.g., the data store component 404). Members of the data store administrator group may have full access permissions for the associated data store component 404 and each component 412, 414, 416, 418, 420, 422, 424, 426, 428, 430, 432, 434, 436, 438, 440, 442, 444, 446 and 448 referenced by the data store component 404, as well as the ability to add and/or remove each data store user from each user group at or below the data store administrator group in the hierarchy associated with the data store component 404 (e.g., data store user groups associated with the data store). Each data store user group may be associated with a particular data store component (e.g., the data store component 404), however, it is common to have a single data store user group associated with each of the data store components 404, 406 referenced by the enterprise component 402. Data store users that are members of a particular data store user group may have access to each data store component associated with the data store user group, the access limited to the access permissions associated with the data store user group but at least including read access. Data store users that are not members of the data store user group associated with a particular data store may not have access to the data store component or the components referenced by the data store component.

Access permissions may include administrative access, node create access, write access, read access and execute access. Data store users with administrative access for a particular heterogeneous data store interface 214 (FIG. 2) component may grant, view, change and remove access permissions associated with the component as well as create, modify and/or delete child data store object component instances of the component. Data store users with node create access may create child data store object component instances for components that may have child components. Data store users with write access for the component may create, modify and delete instances of the component. Data store users with read access may retrieve attribute values of heterogeneous data store interface 214 (FIG. 2) components. Data store users with execute access may trigger secured component behaviors.

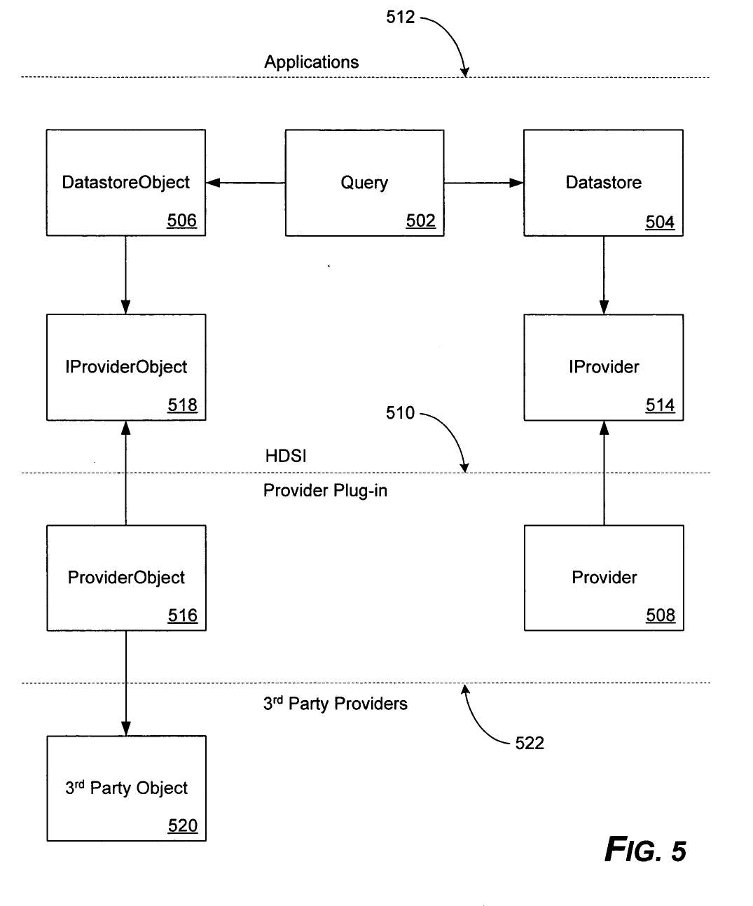

The heterogeneous data store interface 214 (FIG. 2) may further include a query component. Each provider plug-in (e.g., provider plug-ins 218, 220, 222 of FIG. 2) may include a provider component and one or more provider object components. FIG. 5 illustrates example relationships between heterogeneous data store interface components and provider plug-in components in accordance with an embodiment of the invention. Each of the components 502, 504, 506, 508, 514, 516, 518, 520 depicted in FIG. 5 may participate in security policy enforcement.

The query component 502 may have a query specification attribute. Data store components 504 may be queried with the query component 502 for sets of data store object components (DatastoreObject) 506 that have attributes conforming to the query specification of the query component 502. Data store components 404 and 406 of FIG. 4A are examples of data store components 504 that may be queried with the query component 502. Data store object components 412, 414, 416, 418, 420, 422, 424, 426, 428, 430 (FIG. 4A) and data store object components 314 (FIG. 3) are examples of data store object components 506 that may be members of a query result set.

Data store components 504 may implement much of their own functionality in terms of functionality offered by provider components 508. Provider components 508 are components of provider plug-ins (e.g., provider plug-ins 218, 220, 222 of FIG. 2). Data store components 504 are components of the heterogeneous data store interface 214 (FIG. 2). A dashed line 510 marks the boundary between the heterogeneous data store interface and provider plug-ins, and may mark a local/remote boundary, that is, the heterogeneous data store interface and provider plug-ins may be located on different computers. Another dash line 512 marks the boundary between the heterogeneous data store interface and applications that interact with the heterogeneous data store interface.

Each provider component 508 has an object-oriented application programming interface that conforms to an IProvider provider interface 514. As a result, data store components 504 may ignore differences between particular provider components 508 by implementing data store component 504 functionality in terms of functionality offered by the IProvider provider interface 514. To extend the plug-in analogy: the IProvider provider interface 514 is a socket into which provider plug-in components plug.

A similar relationship exists between the data store object components 506 and provider object components (ProviderObject) 516. Each data store object component 506 may implement much of its own functionality in terms of functionality offered by provider object components 516. Provider object components 516 are components of provider plug-ins (e.g., provider plug-ins 218, 220, 222 of FIG. 2). Data store object components 506 are components of the heterogeneous data store interface 214 (FIG. 2).

Each provider object component 516 has an object-oriented application programming interface that conforms to an IProviderObject provider object interface 518. As a result, data store object components 506 may ignore differences between particular provider object components 516 by implementing data store object component 506 functionality in terms of functionality offered by the IProviderObject provider object interface 518. That is, the IProviderObject provider object interface 518 is another socket into which provider plug-in components plug.

Provider object components 516 may have reference to 3^{rd} party objects 520, for example, interface components or data objects that are a part of the 3^{rd} party application interface 216 (FIG. 2) or the 3^{rd} party application 208. Each provider object component 516 may delegate some of its functionality to a corresponding 3^{rd} party object 520. A dashed line 522 marks the boundary between provider plug-ins and 3^{rd} party providers of interface components or data objects.

Provider object components 516 and 3^{rd} party objects 520 need not be local to each other (i.e., located on the same computer) in order to have reference to one another. However, for 3^{rd} party objects 520 that are local to corresponding provider object components 516, the corresponding provider object components 516 may be lightweight adaptors that enable an object-oriented application programming interface of the local 3^{rd} party objects to conform to the IProviderObject provider object interface 518. In an embodiment of the invention, utilization of the lightweight adaptor form of provider objects when possible results in a significant performance enhancement over utilizing a same communications path for local and remote 3^{rd} party objects 520.

Having given an overview of some heterogeneous data store interface and provider plug-in component relationships, some heterogeneous data store interface and provider plug-in components are now described in more detail. FIG. 6 depicts example details of the enterprise component in accordance with an embodiment of the invention. The enterprise component 602 may include a datastore list attribute 604 and a service list attribute 606. The datastore list attribute 604 of the enterprise component 602 may include a list of data store components, such as data store components 404 and 406 of FIG. 4A. The service list attribute 606 of the enterprise component 602 may include a list of service components, such as service components 408 and 410 of FIG. 4A.

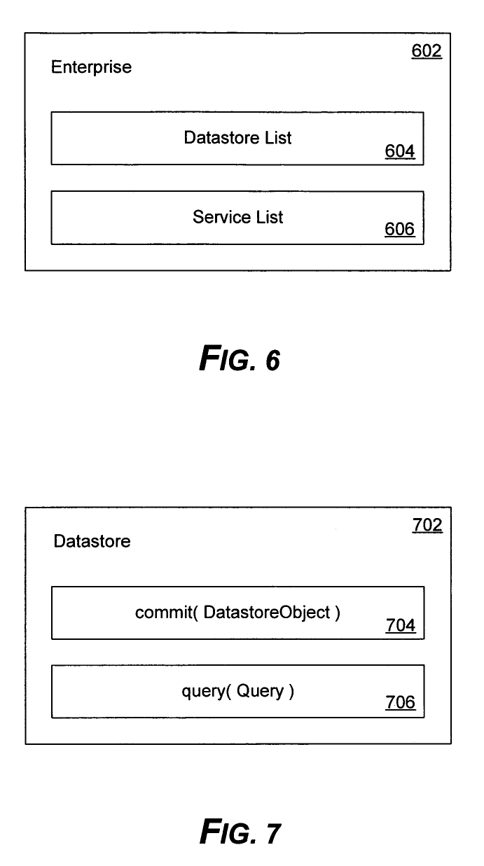

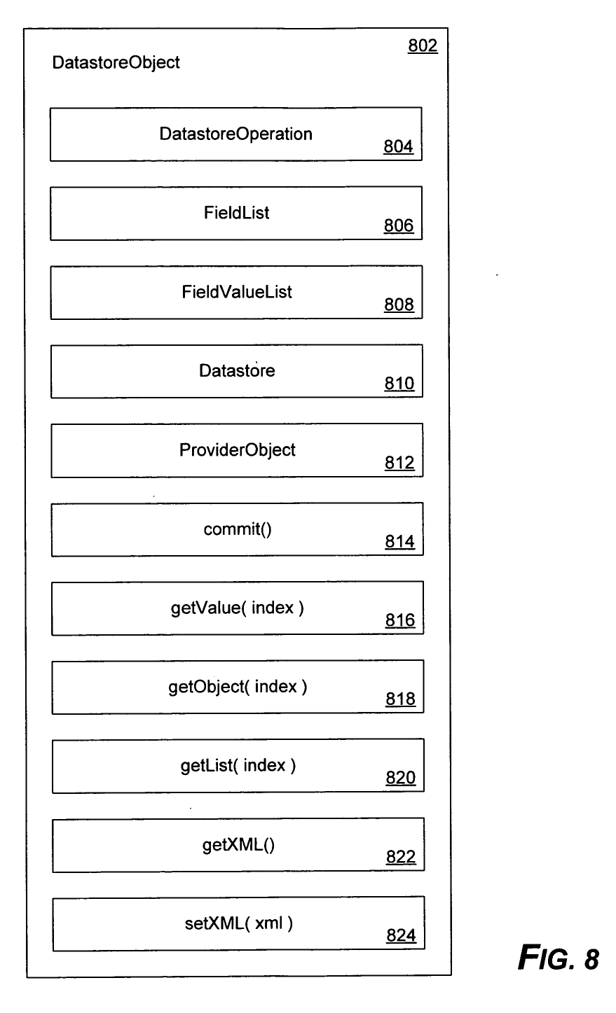

FIG. 7 depicts example details of the data store component in accordance with an embodiment of the invention. The data store component 702 may include a commit behavior 704 and a query behavior 706. For example, the application 202 (FIG. 2) utilizing the heterogeneous data store interface 214 may trigger the query behavior 706 of the data store component 702 and provide the data store component 702 with an instance of the query component 502 (FIG. 5). Unless otherwise indicated herein or clearly contradicted by context, a particular behavior of a particular component may be triggered by invoking a corresponding procedure of the component, and a first component may be provided to a second component by passing the first component (e.g., by value or by reference) as a parameter of a procedure of the second component. In addition, the first component may be provided to the second component as a result of a procedure invoked by the second component. For example, component behaviors may be implemented as functions or procedures of one of the object-oriented programming languages.

As a result of triggering the query behavior 706 of the data store component 702, the data store component 702 may provide the application 202 with one or more data store object components 506. The application 202 may change one or more of the provided data store object components 506. The changes to a particular data store object component 506 may be committed to the data store associated with the data store component 702 by triggering the commit behavior 704 of the data store component 702 and providing the particular data store object component 506 to be committed.

FIG. 8 depicts example details of the data store object component in accordance with an embodiment of the invention. A data store object component (DatastoreObject) 802 may include a data store operation attribute (DatastoreOperation) 804, a field list attribute (FieldList) 806, a field value list attribute (FieldValueList) 808, a data store attribute (Datastore) 810, and a provider object attribute (ProviderObject) 812. The data store object component 802 may further include a commit behavior 814, a get value behavior (getValue) 816, a get object behavior (getObject) 818, a get list behavior (getList) 820, a get extensible markup language behavior (getXML) 822, and a set from extensible markup language behavior (setXML) 824.

The data store attribute 810 may reference an instance of the data store component 404 (FIG. 4A) associated with the enterprise data store in which the data store object component 802 is stored. Triggering the commit behavior 814 of the data store object component 802 may in turn trigger the commit behavior 704 of the data store component 404 referenced by the data store attribute 810 and provide the data store object component 802 as the data store object component to be committed. Data store operation attribute 804 values may include create, update and delete. The data store operation attribute 804 value may indicate the nature of the operation to be performed when the data store object component 802 is committed.

Each data store object component 802 may be associated with a particular data object stored in the enterprise data store referenced by the data store attribute 810 (i.e., a particular enterprise data object). The field list attribute 806 may include a field specification for each attribute of the data object associated with the data store object component 802 instance. The table below sets out an example set of properties that may be included in the field specification.

TABLE 1

| Property Name | Property Type |
|---|---|
| DefaultValue | string |
| IsDefer | boolean |
| IsIdentity | boolean |
| IsNullable | boolean |
| IsReadOnly | boolean |
| MaxLength | integer |
| Name | string |
| SchemaPath | string |
| StorageType | Value, object or list of objects |
| Type | C# Type |
| ValidOperators | A set of query operators |
| ValueIndex | integer |

In the above table, the DefaultValue property of the field specification may specify a default value for a particular data object attribute as a string of alphanumeric characters. The defer (IsDefer) property may specify if, by default, the data object attribute should be retrieved from the enterprise data store as soon as the data store object component 802 instance is created or if the computational work associated with retrieving the data object attribute may be deferred until some later time, for example, deferred until the data object attribute is accessed by the application 202 (FIG. 2). That is, the defer property may specify if the data object attribute is deferrable. Data object attributes may be accessed with the data store object component 802 get value, get object and get list behaviors 816, 818 and 820 as described in more detail below. In an embodiment of the invention, the ability to defer retrieval of data object attributes significantly enhances the performance of applications 202, 204, 206 utilizing the heterogeneous data store interface 214 to access enterprise data stores 208, 210, 212.

The IsIdentity property may specify if the particular data object attribute is one of the attributes of the data object that determines an identity of the data object (i.e., an identity attribute). For example, each identity attribute of the data object should be compared in order to compare two data objects of the same type. The IsNullable property may specify if the data object attribute may take on a null value, for example, as distinct from a zero integer value or an empty string value. The IsReadOnly property may specify if the data object attribute is read only, that is, may not be changed in the enterprise data store. The MaxLength property may specify the maximum length of the data object attribute for data object attributes that have a variable length, for example, strings of alphanumeric characters. The Name property may specify a name of the data object attribute as a string.

If the data object attribute is a list of data objects then the SchemaPath property of the field specification may be a schema path for retrieving the list from the enterprise data store. For example, the schema path string may have the form “@DataObject2:AttributeB-AttributeA@DataObject1” where DataObject1 is the name of a first type of data object, AttributeA is the name of one of the attributes of DataObject1, DataObject2 is the name of a second type of data object, and AttributeB is the name of one of the attributes of DataObject2. In this example, the schema path string may be interpreted as: retrieve each data object of type DataObject2 with AttributeB equal to AttributeA of a data object of type DataObject1.

In a further example, the schema path string may have the form “@DO3:AttrC-AttrB2@DO2:AttrB1˜AttrA@DO1” where DO1, DO2 and DO3 are the names of a first, second and third types of data object, AttrA is the name of one of the attributes of DO1, AttrB1 is the name of a first attribute of DO2, AttrB2 is the name of a second attribute of DO2, and AttrC is the name of one of the attributes of DO3. In this further example, the schema path string may be interpreted as: determine a set of data objects of type DO2 each with attribute AttrB1 equal to attribute AttrA of a data object of type DO1 and, for each value of attribute AttrB2 of the data objects in the set, retrieve each data object of type DO3 with attribute AttrC equal to the value of attribute AttrB2. The schema path string form of this further example may be utilized when there is a many-to-many relationship between data objects of type DO1 and data objects of type DO3.

The StorageType property of the example field specification in the above table may specify a storage type of the particular data object attribute, that is, whether the data object attribute is a value, a data object or a list of data objects. A value may be a simple type such as integer, string or floating point value. Retrieving a data object may include retrieving a set of values. Retrieving a list of data objects may include retrieving one or more data objects. In an embodiment of the invention, distinguishing the storage type of the data object attribute enhances the performance of applications 202, 204, 206 (FIG. 2) utilizing the heterogeneous data store interface 214 to access enterprise data stores 208, 210, 212.

The Type property may specify the object-oriented programming language type of the data object attribute, for example, the C# type of the data object attribute. The ValidOperators property may specify the set of query operators that are valid for the data object attribute. See below for further details with regard to query components 502 (FIG. 5) and associated query operators.

The ValueIndex property of the example field specification in the above table may specify an index (e.g., an integer index) into the field value list attribute 808 of the data store object component 802. Where the field list attribute 806 may include a field specification for each attribute of the data object associated with the data store object component 802 instance, the field value list attribute 808 may include a value for each attribute of the data object associated with the data store object component 802 instance. If the data object attribute is a simple type then the field value list attribute 808 may include the value of the data object attribute. If the data object attribute is a data object then the field value list attribute 808 may include a reference to the data object. If the data object attribute is a list of data objects then the field value list attribute 808 may include a reference to the list of data objects.

The application 202 (FIG. 2) may obtain a particular attribute of a particular data object by triggering the get value, get object or get list behavior 816, 818 or 820 of the data store object component 802 and providing an index of the particular data object attribute. The index of the data object attribute may be the name of the data object attribute (i.e., as specified in the field list attribute 806) or, for example, an integer index into the field value list attribute 808. If the field value list attribute 808 includes the data object attribute value, data object or list of data objects specified by the index then the data store object 802 may provide the value, data object or list of data objects to the application 202 without delay. Otherwise, the data store object component 802 will attempt to retrieve the specified value, data object or list of data objects from the enterprise data store referenced by data store attribute 810, for example, by triggering get value, get object or get list behaviors of the provider object component referenced by the provider object attribute 812.

The application 202 (FIG. 2) may obtain an extensible markup language (XML) representation of the particular data object associated with an instance of the data store object component 802 by triggering the get extensible markup language behavior 822 of the data store object component 802. The application 202 may initialize an instance of the data store object component 802 with the extensible markup language (XML) representation of the associated data object by triggering the set from extensible markup language behavior 824 of the data store object component 802 and providing the extensible markup language representation to the data store object component 802. Extensible markup language (XML) is known in the art and need not be detailed here.

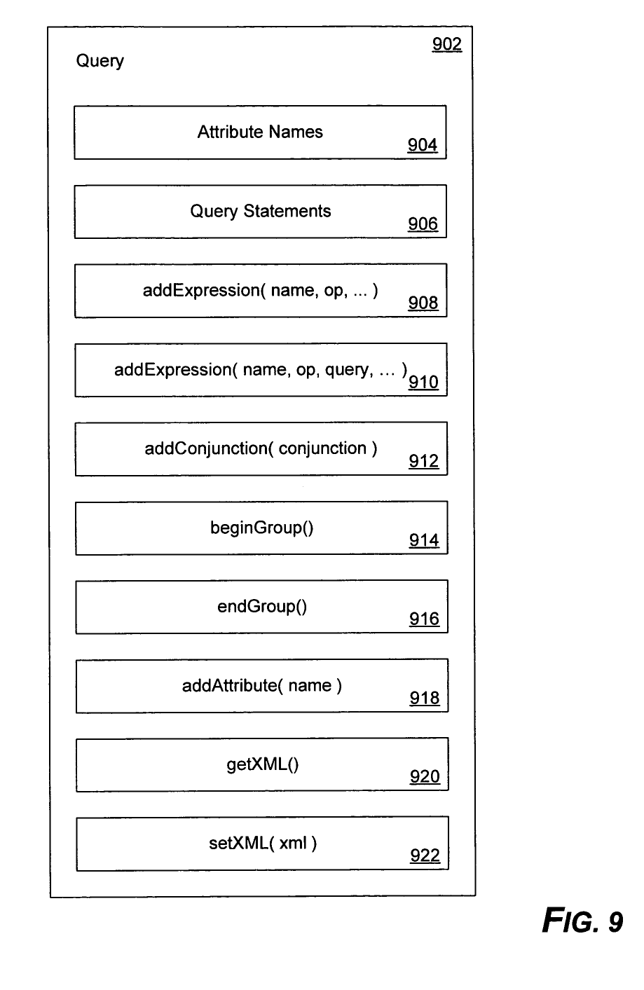

FIG. 9 depicts example details of the query component in accordance with an embodiment of the invention. A query component 902 may include an attribute names attribute 904 and a query statements attribute 906. The query component 902 may further include add expression behaviors (addExpression) 908 and 910, an add conjunction behavior (addConjunction) 912, a begin group behavior (beginGroup) 914, an end group behavior (endGroup) 916, an add attribute behavior (addAttribute) 918, a get extensible markup language behavior (getXML) 920 and a set from extensible markup language behavior (setXML) 922.

Enterprise data stores may collectively contain a plurality of data objects, that is, a set of enterprise data objects. Although, for example, the application 202 (FIG. 2) may interact with each enterprise data object, typically the application 202 interacts with a subset of enterprise data objects during a given period of time. The query component 902 of the heterogeneous data store interface 214 may specify a particular subset of enterprise data objects.

Each enterprise data object may include a set of data object attributes. Although the application 202 may interact with each data object attribute, the application 202 may interact with a subset of the data object attributes, for example, to implement a particular function. The query component 902 may further specify a particular subset of data object attributes of a particular subset of enterprise data objects.

The attribute names attribute 904 may include one or more names of attributes of enterprise data objects, for example, the name of the data object attribute as specified in the field list attribute 806 of the data store object component 802 associated with the data object. The data object attributes names included in the attribute names attribute 904 of the query component 902 may be the subset of data object attributes specified by the query component 902. If the attribute names attribute 904 is empty then the subset of data object attributes specified by the query component 902 may be each of the data object attributes of the subset of enterprise data objects specified by the query component 902.

The query statements attribute 906 may include one or more query statements that, in conjunction, specify the subset of enterprise data objects. Each query statement may include query expressions, query conjunctions, query expression grouping indicators, and query modifiers. Query expressions may include query operators and query terms such as data object attribute names and values. Query expressions and query modifiers may reference further query components 902.

“AttributeA” is an example of a data object attribute name. If the data object attribute name is unique, for example, with respect to a particular enterprise data store, no additional qualification of the data object attribute name may be required. If the data object attribute name is not unique then addition qualification, for example, of the form “DataObject1.AttributeA”, may be required. Values may be expressed as strings, for example, “−101”, “1.02”, “example string”. The following table lists examples of suitable query operators.

TABLE 2

| Operator Name | Comments |
|---|---|
| Equals | Identity comparison |
| NotEquals | Inverse of Equals |
| Less | Less than comparison |
| EqualsLess | Less than or equal to |
| Greater | Greater than comparison |
| EqualsGreater | Greater than or equal to |
| Contains | Set 1 contains set 2 |
| NotContains | Set 1 does not contain set 2 |
| Within | Value is within set 2 |
| NotWithin | Value is not within set 2 |
| Has | Object has a member of a set |
| HasNot | Object does not have a member of a set |
| IsNull | Attribute value is null |
| IsNotNull | Attribute value is not null |

The example query operators in Table 2 above may be provided to the add expression behavior 908 of the query component 902 as part of a process of instantiating query statements. For example, the add expression behavior 908 may be triggered with parameters: data object attribute name AttributeA, query operator Equals and value −101. As a result, the query component 902 may specify a subset of enterprise data objects that have an attribute named AttributeA with a value equal to −101. Similarly, triggering the add expression behavior 908 of the query component 902 with parameters: data object attribute name DataObject1.AttributeA, query operator Less and value 1.02, may specify a subset of enterprise data objects of type DataObject1 that have an attribute named AttributeA with a value that is less than 1.02.

The example query operators Equals, NotEquals, Less, EqualsLess, Greater and EqualsGreater in Table 2 above have their familiar meanings. The attribute contains (Contains) query operator may be utilized to specify a subset of enterprise data objects with attribute values that may themselves contain subsets, for example, string values that may contain substrings. The value within (Within) query operator may be utilized to specify a subset of enterprise data objects with attribute values that are within a given set of values, for example, attribute values that are within a set of values specified by another query component 902. The Has query operator may be utilized to specify a first subset of enterprise data objects each of which has (e.g., has reference to) at least one of a second specified subset of enterprise data objects. The null test (IsNull) query operator is a unary operator that may be utilized to specify a subset of enterprise data objects with attributes that have a null value. Query operators NotContains, NotWithin, HasNot and IsNotNull are the inverse of query operators Contains, Within, Has and IsNull respectively.

For example, the application 202 (FIG. 2) may add query expressions to the query statements attribute 906 by triggering the add expression behavior 908 and providing at least one data object attribute name and one of the query operators. The application 202 may add query expressions that reference other query components 902 by triggering the add expression behavior 910 and providing at least one data object attribute name, one of the query operators and an instance of the query component 902. For example, the application 202 may instantiate a first query component 902 specifying a particular subset of enterprise data objects, then trigger the add expression behavior 910 of a second query component 902 and provide a first data object attribute name AttributeA, query operator Within, the first query component 902 and a second data object attribute name AttributeB. The second query component 902 may specify a subset of enterprise data objects with attribute AttributeA values that are within the set of attribute AttributeB values of the subset of enterprise data objects specified by the first query component 902.

The application 202 (FIG. 2) may compound query expressions by triggering the add conjunction behavior 912 of the query component 902, and providing a query conjunction, after triggering the add expression behavior 908, 910 for a first query expression and before triggering the add expression behavior for a second query expression. Suitable query conjunctions include an ‘and’ query conjunction and an ‘or’ query conjunction. For example, the application 202 may trigger a first add expression behavior 908 of the query component 902 with parameters AttributeA, Greater and 5, then trigger an add conjunction behavior 912 of the query component 902 with query conjunction ‘and’, and then trigger a second add expression behavior 908 of the query component 902 with parameters AttributeA, Less, and 10. The query component 902 may then specify a subset of enterprise data objects with attribute AttributeA values between 5 and 10.

The application 202 (FIG. 2) may group query expressions by triggering the begin group behavior 914 and the end group behavior 916 of the query component 902 before and after the query expression to be grouped. For example, the application 202 may trigger a third add expression behavior 908 of the query component 902 with parameters AttributeB and IsNotNull and then trigger an add conjuction behavior 912 of the query component 902 with query conjuction ‘or’. Next, the application 202 may trigger the begin group behavior 914 of the query component 902, then the add expression, add conjunction and add expression behaviors as described in the previous paragraph, and then the end group behavior 916. As a result, the query component 902 may specify a subset of enterprise data objects with attribute AttributeB values that are not null or with attribute AttributeA values between 5 and 10.

The application 202 (FIG. 2) may add data object attribute names to the attribute names attribute 904 of the query component 902 by triggering the add attribute behavior 918 and providing one or more data object attribute names. For example, having specified a subset of enterprise data objects as described in the previous paragraph, the application 202 may further trigger the add attribute behavior 918 of the query component 902 and provide data object attribute names AttributeC and AttributeD. As a result, the query component 902 may specify the attributes AttributeC and AttributeD of the subset of enterprise data objects with attribute AttributeB values that are not null or with attribute AttributeA values between 5 and 10. In an embodiment of the invention, the ability to specify a subset of data object attributes to retrieve significantly enhances the performance of applications 202, 204, 206 utilizing the heterogeneous data store interface 214 to access enterprise data stores 208, 210, 212.

The application 202 (FIG. 2) may obtain an extensible markup language (XML) representation of the enterprise data object subset specification associated with the query component 902 by triggering the get extensible markup language behavior 920 of the query component 902. The application 202 may provide a particular enterprise data object subset specification to an instance of the query component 902 by triggering the set from extensible markup language behavior 922 of the query component 902 instance and providing the extensible markup language representation of the particular enterprise data object subset specification as a parameter. The extensible markup language representation of the enterprise data object subset specification associated with the query component 902 includes an extensible markup language representation of the attribute names attribute 904 and the query statements attribute 906 of the query component 902.

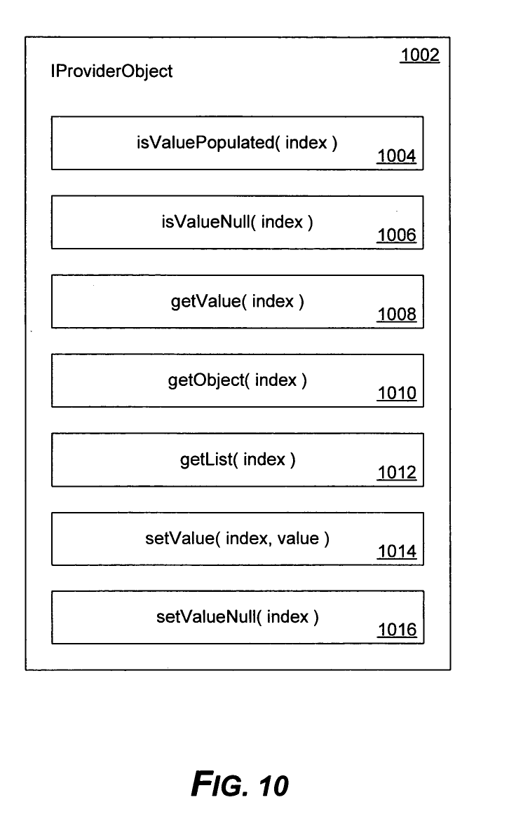

FIG. 10 depicts example details of the provider object interface in accordance with an embodiment of the invention. A provider object interface (IProviderObject) 1002 may include a populated value test (isValuePopulated) component behavior specification 1004, a null value test (isValueNull) component behavior specification 1006, a get value (getValue) component behavior specification 1008, a get object (getObject) component behavior specification 1010, a get list (getList) component behavior specification 1012, a set value (setValue) component behavior specification 1014 and a set null value (setValueNull) component behavior specification 1016. In an embodiment of the invention, each provider object component 516 (FIG. 5) conforming to the provider object interface 1002 implements each component behavior specification 1004, 1006, 1008, 1010, 1012, 1014, 1016 of the provider object interface 1002.

The provider object component 516 (FIG. 5) may retrieve data object attribute values from enterprise data stores. Retrieving data object attribute values may require computational resources. As a result, retrieval of data object attribute values may be delayed or deferred. If a particular data object attribute value has been retrieved, that data object attribute value is populated. The populated value test component behavior specification 1004 may specify that each provider object component 516 include a populated value test behavior with a data object attribute index (e.g., an integer index) parameter. When triggered, the populated value test behavior may return (i.e., provide to the triggering component) a true result if the value of the data object attribute indexed by the data object attribute index parameter is populated and a false result otherwise.

The null value test component behavior specification 1006 may specify that each provider object component 516 (FIG. 5) include a null value test behavior with a data object attribute index parameter. When triggered, the null value test behavior may return a true result if the value of the data object attribute indexed by the data object attribute index parameter is null. Otherwise the null value test behavior may return a false result.

The get value component behavior specification 1008 may specify that each provider object component 516 (FIG. 5) include a get value behavior with a data object attribute index parameter. If the data object attribute indexed by the data object attribute index parameter is a simple type then, when triggered, the get value behavior may return the value of the data object attribute indexed by the data object attribute index parameter. Otherwise, the get value behavior may return a value indicating that the data object attribute indexed by the data object attribute index parameter is not a simple type, for example, a null value or a default value.

The get object component behavior specification 1010 may specify that each provider object component 516 (FIG. 5) include a get object behavior with a data object attribute index parameter. If the data object attribute indexed by the data object attribute index parameter is an enterprise data object then, when triggered, the get object behavior may return the provider object component 516 associated with the enterprise data object referenced by the data object attribute that is indexed by the data object attribute index parameter. Otherwise, the get object behavior may return a value indicating that the data object attribute indexed by the data object attribute index parameter is not an enterprise data object, for example, a null value or a default provider object component 516.

The get list component behavior specification 1012 may specify that each provider object component 516 (FIG. 5) include a get list behavior with a data object attribute index parameter. If the data object attribute indexed by the data object attribute index parameter is list of enterprise data objects then, when triggered, the get list behavior may return a list of the provider object components 516 associated with the enterprise data objects referenced by the data object attribute that is indexed by the data object attribute index parameter. Otherwise, the get list behavior may return a value indicating that the data object attribute indexed by the data object attribute index parameter is not a list of enterprise data objects, for example, a null value or an empty list.

The set value component behavior specification 1014 may specify that each provider object component 516 (FIG. 5) include a set value behavior with a data object attribute index parameter and a value parameter to be set. When triggered, the set value behavior may set the value of the data object attribute indexed by the data object attribute index parameter to the value parameter. The value parameter may be a simple type, an enterprise data object or a list of enterprise data objects. Alternatively, the provider object interface 1002 may have asset of three set value, set object and set list component behavior specifications (not shown in FIG. 10) corresponding to the get value, get object and get list component behavior specifications 1008, 1010 and 1012.

The set null value component behavior specification 1016 may specify that each provider object component 516 (FIG. 5) include a set null value behavior with a data object attribute index parameter. If the data object attribute indexed by the data object attribute index parameter is able to be set to the null value then, when triggered, the set null value behavior may set the value of the data object attribute to the null value. Otherwise, the set null value behavior may return a code indicating that the data object attribute indexed by the data object attribute index parameter may not be set to the null value.

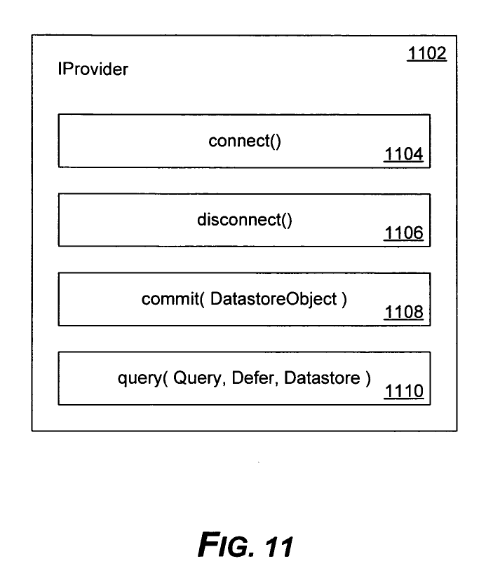

FIG. 11 depicts example details of the provider interface in accordance with an embodiment of the invention. A provide interface (IProvider) 1102 may include a connect component behavior specification 1104, a disconnect component behavior specification 1106, a commit component behavior specification 1108 and a query component behavior specification 1110. In an embodiment of the invention, each provider component 508 (FIG. 5) conforming to the provider interface 1102 implements each component behavior specification 1104, 1106, 1108 and 1110 of the provider interface 1102.

The connect component behavior specification 1104 may specify that each provider component 508 (FIG. 5) include a connect behavior. When triggered, the connect behavior may establish a communications connection between the provider component 508 and the enterprise data store associated with the provider component 508. Similarly, the disconnect component behavior specification 1106 may specify that each provider component 508 include a disconnect behavior that, when triggered, terminates the communications connection between the provider component 508 and the associated enterprise data store. The connect component behavior specification 1104 may specify that an associated data store connect security policy be enforced by each provider component 508. Alternatively, for example, data store components 504 associated with each enterprise data store may enforce the data store connect security policy before triggering the connect behavior of the provider component 508.

The commit component behavior specification 1108 may specify that each provider component 508 (FIG. 5) include a commit behavior with a data store object component 504 parameter. When triggered, the commit behavior may commit any changes to the data store object component 504 to the enterprise data store associated with the provider component 508, for example, changes to the values of the attributes of the data store object associated with the data store object component 504. The value of the data store operation attribute 804 (FIG. 8) of the data store object component 802 may determine the nature of the operation to be performed when the data store object component 802 is committed. The provider interface 1102 may further include a commit component behavior specification (not shown in FIG. 11) that specifies that each provider component 508 include a further commit behavior with a list of data store object components 504 as a parameter. This further commit behavior may commit each data store object component 504 in the list referenced by the parameter.

The query component behavior specification 1110 may specify that each provider component 508 (FIG. 5) include a query behavior with a query component 502 parameter, a defer parameter and a data store component 504 parameter. When triggered, the query behavior of the provider component 508 may return a set of data store object components 506 corresponding to the subset of enterprise data objects specified by the query component 502 parameter that are stored in the enterprise data store associated with the data store component 504 parameter. If the defer parameter has a true value then the set of data store object components 506 may be returned by the provider component 508 without retrieving the data object attribute values associated with each data store object component 506 in the set. Otherwise, the provider component 508 may retrieve those data object attribute values that are not deferred by default, for example, as determined by the IsDefer property for each data object attribute as described above with reference to FIG. 8.

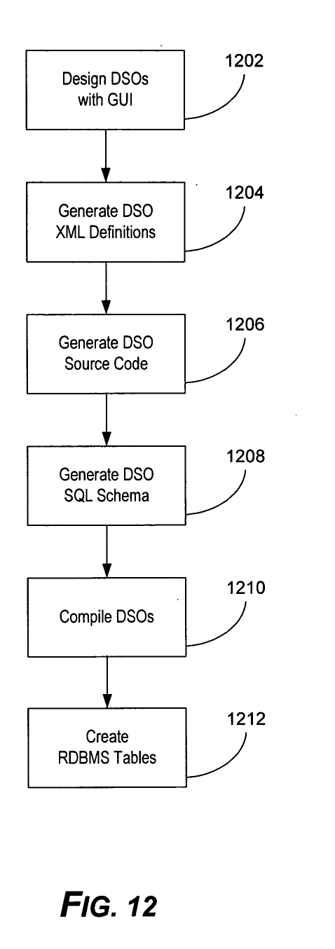

Example procedures performed by modules and components in accordance with an embodiment of the invention are now described in more detail. FIG. 12 depicts example steps that may be performed to generate data store object components for the heterogeneous data store interface in accordance with an embodiment of the invention. At step 1202, graphical representations of data store objects (DSO) may be built with the data store object design graphical user interface (GUI) 302 (FIG. 3). For example, the data store objects may be built in accordance with Unified Modeling Language (UML) graphical representations. Unified Modeling Language is known in the art and need not be detailed here.

At step 1204, extensible markup language (XML) data store object definitions 306 may be generated by the extensible markup language data store object definition generator 304 in accordance with the extensible markup language data store object definition schema 308. The table below lists aspects of an example extensible markup language data store object definition schema.

```
TABLE 3
<?xml version=“1.0”?>
<xs:schema id=“DSObjects” targetNamespace=“http://tempuri.org/
dso.xsd”
xmlns:mstns=“http://tempuri.org/dso.xsd” xmlns=“http://tempuri.org/
dso.xsd”
xmlns:xs=“http://www.w3.org/2001/XMLSchema” xmlns:msdata=“urn:
schemas-microsoft-com:xml-msdata” attributeFormDefault=“qualified”
elementFormDefault=“qualified”>
  <xs:element name=“DSObjects” msdata:IsDataSet=“true”
msdata:EnforceConstraints=“False”>
    <xs:complexType>
      <xs:choice maxOccurs=“unbounded”>
        <xs:element name=“dsobject”>
          <xs:complexType>
            <xs:sequence>
        <xs:element name=“comment” type=“xs:string” minOccurs=“0”
msdata:Ordinal=“0” />
        <xs:element name=“dsfield” minOccurs=“0”
maxOccurs=“unbounded”>
          <xs:complexType>
            <xs:sequence>
              <xs:element name=“comment” type=“xs:string”
minOccurs=“0” msdata:Ordinal=“0” />
            </xs:sequence>
            <xs:attribute name=“ID” form=“unqualified”
type=“xs:string” />
            <xs:attribute name=“DSObjectID” form=“unqualified”
type=“xs:string” />
            <xs:attribute name=“FieldName” form=“unqualified”
type=“xs:string” />
            <xs:attribute name=“FieldType” form=“unqualified”
type=“xs:string” />
            <xs:attribute name=“IsPrimary” form=“unqualified”
type=“xs:string” />
            <xs:attribute name=“IsIdentity” form=“unqualified”
type=“xs:string” />
            <xs:attribute name=“IsNullable” form=“unqualified”
type=“xs:string” />
            <xs:attribute name=“MaxLength” form=“unqualified”
type=“xs:string” />
            <xs:attribute name=“IsClonable” form=“unqualified”
type=“xs:string” />
            <xs:attribute name=“IsReadOnly” form=“unqualified”
type=“xs:string” />
            <xs:attribute name=“IsExtended” form=“unqualified”
type=“xs:string” />
            <xs:attribute name=“IsDefer” form=“unqualified”
type=“xs:string” />
            <xs:attribute name=“FKObject” form=“unqualified”
type=“xs:string” />
            <xs:attribute name=“FKField” form=“unqualified”
type=“xs:string” />
            <xs:attribute name=“DefaultValue” form=“unqualified”
type=“xs:string” />
          </xs:complexType>
        </xs:element>
        <xs:element name=“row” minOccurs=“0” maxOccurs=“
        unbounded”>
          <xs:complexType>
            <xs:attribute name=“ID” form=“unqualified”
type=“xs:string” />
            <xs:attribute name=“EnumConstant” form=“unqualified”
type=“xs:string” />
          </xs:complexType>
        </xs:element>
      </xs:sequence>
      <xs:attribute name=“ID” form=“unqualified” type=“xs:string” />
      <xs:attribute name=“Name” form=“unqualified”
      type=“xs:string” />
      <xs:attribute name=“IsMaster” form=“unqualified”
type=“xs:string” />
            <xs:attribute name=“IsEnum” form=“unqualified”
type=“xs:string ”/>
            <xs:attribute name=“IsObjectSecured” form=“unqualified”
type=“xs:string” />
            <xs:attribute name=“IsPermissionObject”
form=“unqualified” type=“xs:string” />
            <xs:attribute name=“IsInternal” form=“unqualified”
type=“xs:string” />
            <xs:attribute name=“IsPSObject” form=“unqualified”
type=“xs:string” />
            <xs:attribute name=“ViewName” form=“unqualified”
type=“xs:string” />
            <xs:attribute name=“Namespace” form=“unqualified”
type=“xs:string” />
            <xs:attribute name=“ParentName” form=“unqualified”
type=“xs:string” />
            <xs:attribute name=“ParentLinkField” form=“unqualified”
type=“xs:string” />
            <xs:attribute name=“StorageType” form=“unqualified”
type=“xs:string” />
          </xs:complexType>
        </xs:element>
      </xs:choice>
    </xs:complexType>
  </xs:element>
</xs:schema>
```

The example extensible markup language data store object definition schema in the above table describes an extensible markup language format suitable for defining data store objects. For example, each data store object definition (i.e., dsobject element) may include a sequence of data store object attribute definitions (i.e., dsfield elements), and each data store object attribute definition may include definition attributes such as IsIdentity, IsNullable, IsReadOnly and other properties as described above with reference to the field list attribute 806 of FIG. 8. The table below lists aspects of an example extensible markup language data store object definition for a particular data store object.

```
TABLE 4
  <dsobject ID=“127” Name=“Task” IsMaster=“false” IsEnum=“false”
IsObjectSecured=“false” IsPermissionObject=“false” IsInternal=“false”
IsPSObject=“true” ViewName=“Task_View” Namespace=“Jobs”
ParentName=“Job”
ParentLinkField=“JobID” StorageType=“list”>
    <comment>Stores the tasks that belong to a given job</comment>
    <dsfield ID=“1015” DSObjectID=“127” FieldName=“ID”
    FieldType=“int”
IsPrimary=“true” IsIdentity=“true” IsNullable=“false” MaxLength=“4”
IsClonable=“true” IsReadOnly=“false” IsExtended=“false”
IsDefer=“false”>
      <comment>SQL Assigned Identifier</comment>
    </dsfield>
    <dsfield ID=“1016” DSObjectID=“127” FieldName=“Name”
FieldType=“nvarchar” IsPrimary=“false” IsIdentity=“false”
IsNullable=“false”
MaxLength=“256” IsClonable=“true” IsReadOnly=“false”
IsExtended=“false” IsDefer=“false”>
      <comment>Name of Task</comment>
    </dsfield>
    <dsfield ID=“1017” DSObjectID=“127” FieldName=“JobID”
FieldType=“int” IsPrimary=“false” IsIdentity=“false” IsNullable=“false”
MaxLength=“4” FKObject=“Job” FKField=“ID” IsClonable=“true”
IsReadOnly=“false” IsExtended=“false” IsDefer=“false”>
      <comment>Foreign key to Job (ID)</comment>
    </dsfield>
    <dsfield ID=“1018” DSObjectID=“127” FieldName=“GUID”
FieldType=“uniqueidentifier” IsPrimary=“false” IsIdentity=“false”
IsNullable=“false” MaxLength=“16” DefaultValue=“(newid())”
IsClonable=“false” IsReadOnly=“false” IsExtended=“false”
IsDefer=“false”>
      <comment>unique identifier</comment>
    </dsfield>
    ...
    <dsfield ID=“1031” DSObjectID=“127” FieldName=
    “SequenceNumber”
FieldType=“int” IsPrimary=“false” IsIdentity=“false” IsNullable=“false”
MaxLength=“4” DefaultValue=“(0)” IsClonable=“true”
IsReadOnly=“false” IsExtended=“false” IsDefer=“false”>
      <comment>Task ID for sequential execution</comment>
    </dsfield>
    <dsfield ID=“1032” DSObjectID=“127” FieldName=“JobLMSName”
FieldType=“nvarchar” IsPrimary=“false” IsIdentity=“false”
IsNullable=“true”
MaxLength=“256” IsClonable=“true” IsReadOnly=“false”
IsExtended=“false” IsDefer=“false” />
  </dsobject>
```

The above table shows aspects of an example extensible markup language data store object definition for a Task data object. The extensible markup language data store object definition is abbreviated for clarity. In accordance with the example extensible markup language data store object definition schema, the data store object definition (dsobject) element includes a sequence of data store object attribute definition (dsfield) elements, and each data store object attribute definition element has definition attributes such as IsIdentity, IsNullable, IsReadOnly and other properties as described above with reference to the field list attribute 806 of FIG. 8.

At step 1206, the data store object source code generator 310 (FIG. 3) may generate data store object source code 312, for example, C# object-oriented programming language source code, from the extensible markup language data store object definitions 306. At step 1208, the data store object source code generator 310 may invoke the structured query language generator plug-in 316 to generate data store object structured query language schema 318 from the extensible markup language data store object definitions 306. A plurality of data store object generator plug-ins may be invoked by the data store object source code generator 310.

At step 1210, the data store object source code 312 may be compiled with a suitable object-oriented programming language compiler to create data store object components 314 corresponding to the graphical representations of the data store objects built in step 1202. At step 1212, the data store object structured query language schema 318 may be applied one or more databases managed by the relational database management system 212 to create relational database tables suitable for storing enterprise data objects corresponding to the graphical representations of the data store objects built in step 1202. Some data store object generator plug-ins may create enterprise data objects directly in the enterprise data store from the extensible markup language data store object definitions 306. For such data store object generator plug-ins, the generation of an intermediate representation at step 1208 may be skipped.

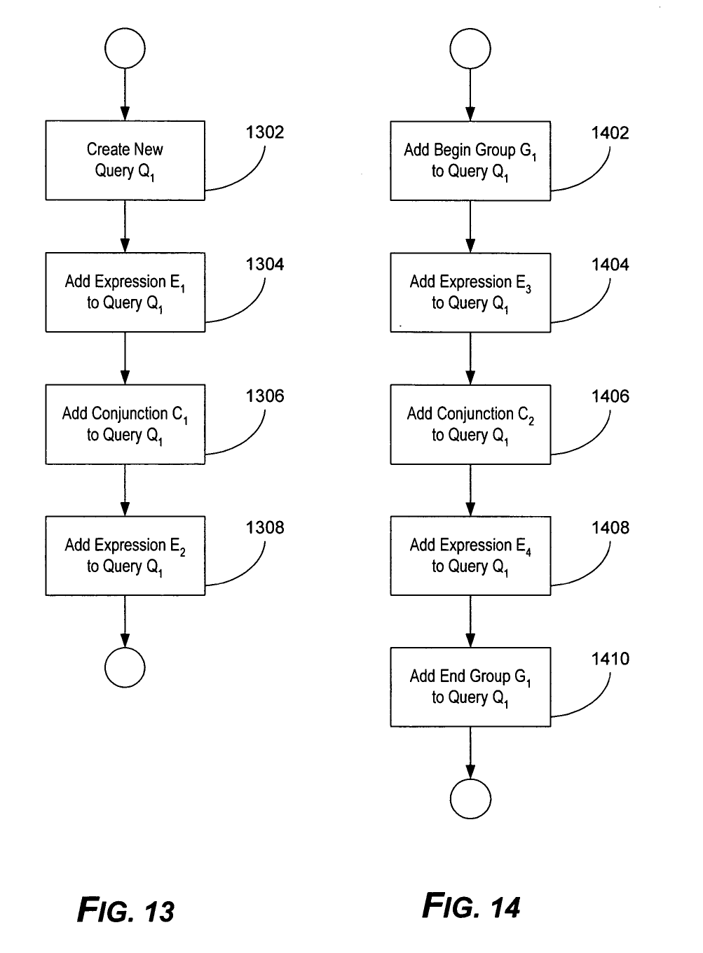

FIG. 13 depicts example steps that may be performed to configure the query component of the heterogeneous data store interface in accordance with an embodiment of the invention. At step 1302, a new instance Q, of the query component 502 (FIG. 5) may be instantiated. The subset of enterprise data objects specified by a newly instantiated query component 502 may be the empty set, that is, no enterprise data objects.

At step 1304, a query expression E₁ may be added to the query component instance Q₁. For example, the query expression E₁ may specify that enterprise data objects of type DataObject1 with attribute AttributeA values greater than value V, be included in the subset of enterprise data objects specified by the query component instance Q₁. Further examples of suitable query expressions are described above with reference to FIG. 9.

At step 1306, a query conjunction C₁ may be added to the query component instance Q₁. For example, the query conjunction C₁ may be an ‘or’ type conjunction. At step 1308, a query expression E₂ may be added to the query component instance Q₁. For example, the query expression E₂ may specify that enterprise data objects of type DataObject1 with attribute AttributeB value equal to value V₂ be included in the subset of enterprise data objects specified by the query component instance Q₁. As a result of the query conjunction C₁ added at step 1306, the subset of enterprise data objects specified by the query component instance Q₁ after step 1308 may be those enterprise data objects satisfying query expression E₁ or satisfying query expression E₂.

FIG. 14 depicts example steps incorporating query expression grouping that may be performed to configure the query component of the heterogeneous data store interface in accordance with an embodiment of the invention. The steps depicted by FIG. 14 may, for example, be performed instead of step 1308 of FIG. 13.

At step 1402, a begin group G₁ may be added to the query component instance Q₁. At step 1404, a query expression E₃ may be added to the query component instance Q₁. For example, the query expression E₃ may specify that enterprise data objects specified by the query component instance Q₁ include enterprise data objects of type DataObject1 with attribute AttributeB values that are not null. At step 1406, a query conjunction C₂ may be added to the query component instance Q₁. For example, the query conjunction C₂ may be of the ‘and’ type. At step 1408, a query expression E₄ may be added to the query component instance Q₁. For example, the query expression E₄ may specify enterprise data objects of type DataObject1 with attribute AttributeC value equal to value V₂. At step 1410, an end group G₁ may be added to the query component instance Q₁.

For example, as a result of steps 1302, 1304, 1306 (FIG. 13) and steps 1402, 1404, 1406, 1408, 1410 of FIG. 14, the query component Q₁ may specify the subset of enterprise data objects that are of type DataObject1 with attribute AttributeA values greater than value V₁ or both have non-null attribute AttributeB values and also an attribute AttributeC value that is equal to value V₂. When query expressions are added to query components 502 without query expression grouping, query expression precedence may be unclear.

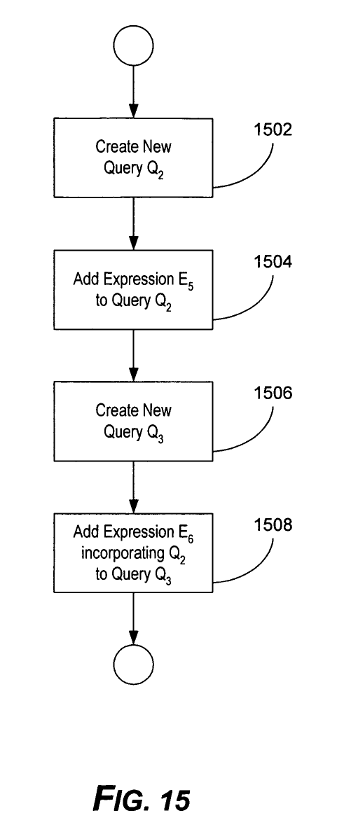

FIG. 15 depicts example steps incorporating query component nesting that may be performed to configure the query component of the heterogeneous data store interface in accordance with an embodiment of the invention. Query component nesting enables query component instances to specify subsets of enterprise data objects in terms of other query component instances. For example, an equivalent of a relational inner join operation may be specified with query component nesting.

At step 1502, a new instance Q₂ of the query component 502 (FIG. 5) may be instantiated. At step 1504, a query expression E₅ may be added to the query component instance Q₂. For example, the query expression E₅ may that specify enterprise data objects of type DataObject2 with attribute AttributeD values less than value V₃ be included in the subset of enterprise data objects specified by the query component instance Q₂.

At step 1506, a new instance Q₃ of the query component 502 (FIG. 5) may be instantiated. At step 1508, a query expression E₆ incorporating the query component instance Q₂ may be added to the new query component instance Q₃. For example, the query expression E₆ may specify that, for each enterprise data object of type DataObject2 in the subset of enterprise data objects specified by the query component instance Q₂, enterprise data objects of type DataObject3 with attribute AttributeE values equal to the attribute AttributeF value of the enterprise data object of type DataObject2 are to be included in the subset of enterprise data objects specified by the query component instance Q₃.

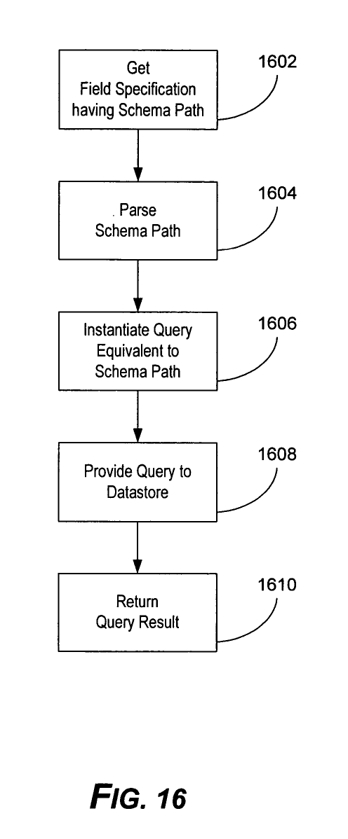

FIG. 16 depicts example steps that may be performed by the data store object component in accordance with an embodiment of the invention. As described above with reference to FIG. 8, the field list attribute 806 of the data store object component 802 may include a schema path for each enterprise data object attribute that references a list of enterprise data objects. The schema path may specify the list of enterprise data objects to be provided to a client of the data store object component 802 (e.g., the application 202 of FIG. 2) when the get list behavior 820 of the data store object component 802 is triggered.

The get list behavior 820 (FIG. 8) of the data store object component 802 may be triggered and an index referencing a particular data object attribute provided. At step 1602, the field specification at the provided index in the field list attribute 806 may be accessed. At step 1604, the schema path of the field specification at the provided index may be parsed for names of enterprise data objects and their associated attributes as well as for relationships between the named enterprise data objects. For example, the schema path string “@DataObject2:AttributeB-AttributeA@DataObject1” may be parsed as: all DataObject2 type data objects with attribute AttributeB equal to attribute AttributeA of a data object of type DataObject1. Where, in this example, the data object of type DataObject1 is the enterprise data object associated with the data store object component 802. Attribute AttributeA and attribute AttributeB are often identity attributes.

At step 1606, an instance of the query component 502 (FIG. 5) may be configured to specify the same subset of enterprise data objects as indicated by the schema path. In this example, a single query expression added to the query component 502 instance may be suitable. The query expression may specify enterprise data objects of type DataObject2 with attribute AttributeB equal to a value. The value being the value in the field value list attribute 808 (FIG. 8) of the data store object component 802 that is associated with the enterprise data object attribute with name AttributeA.

At step 1608, the query component 502 (FIG. 5) instantiated in step 1606 may be provided to the data store component 504 referenced by the data store attribute 810 (FIG. 8) of the data store object component 802 and the query behavior 706 (FIG. 7) of the data store component 504 triggered. The list of data store object components 506 returned by the data store component 504 may be returned, at step 1610, as the result of the get list behavior 820 of the data store object component 802. Other heterogeneous data store interface 214 (FIG. 2) and provider plug-in 218, 220, 222 components may utilize schema path in a similar manner.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A computerized system, comprising:
at least one data store of at least one data store type configured to store at least one data object;
an object-oriented heterogeneous data store interface comprising:
a query component; and
a provider interface comprising a query component behavior specification specifying a query behavior with a query component parameter; and
for each type of data store, a provider plug-in to the object-oriented heterogeneous data store interface, and each provider plug-in comprises at least one provider component configured with a query behavior conforming to the query component behavior specification of the provider interface.

2. The computerized system of claim 1, wherein:
the object-oriented heterogeneous data store interface further comprises a provider object interface comprising:
a get value component behavior specification specifying a get value behavior with a data object attribute index parameter;
a get object component behavior specification specifying a get object behavior with a data object attribute index parameter; and
a get list component behavior specification specifying a get list behavior with a data object attribute index parameter; and
each provider plug-in further comprises at least one provider object component, and each provider object component is configured with:
a get value behavior conforming with the get value component behavior specification of the provider object interface;
a get object behavior conforming with the get object component behavior specification of the provider object interface;
a get list behavior conforming with the get list component behavior specification of the provider object interface; and
an index of attributes of at least one of said at least one data object.

3. The computerized system of claim 2, wherein the provider object interface further comprises:
a set value component behavior specification specifying a set value behavior with a data object attribute index parameter;
a set null value component behavior specification specifying a set null value behavior with a data object attribute index parameter;
a null value test component behavior specification specifying a null value test behavior with a data object attribute index parameter; and
a populated value test component behavior specification specifying a populated value test behavior with a data object attribute index parameter.

4. The computerized system of claim 1, wherein:
the object-oriented heterogeneous data store interface further comprises at least one data store object component; and
the provider interface further comprises:
a connect component behavior specification specifying a connect behavior;
a disconnect component behavior specification specifying a disconnect behavior; and
a commit component behavior specification specifying a commit behavior with a data store object component parameter.

5. The computerized system of claim 4, wherein:
each data store object component comprises a data store operation attribute;
each provider component is further configured with a commit behavior conforming to the commit component behavior specification of the provider interface; and
the data store operation attribute of the data store object component parameter of the commit behavior of the provider component indicates a data store operation to occur during the commit.

6. The computerized system of claim 1, wherein the object-oriented heterogeneous data store interface further comprises:
for each data object stored in each data store, a data store object component; and
a data store component configured to provide a subset of data store object components in response to the query component.

7. The computerized system of claim 1, wherein the query component is configured with:
an add expression behavior having:
at least one query term parameter; and
a query operator parameter; and
an add conjunction behavior having a query conjunction parameter.

8. The computerized system of claim 7, wherein the add expression behavior of the query component further has a query component parameter.

9. The computerized system of claim 1, wherein:
each data object stored in said at least one data store comprises at least one data object attribute;
the object-oriented heterogeneous data store interface further comprises a data store object component corresponding to each data object stored in each data store; and
each data store object component comprises a field list attribute comprising a field specification for at least one data object attribute of the data object corresponding to the data store object component, the field specification comprising a defer property specifying that retrieval of the data object attribute is deferrable.

10. The computerized system of claim 9, wherein:
said at least one data object attribute comprises a data object attribute referencing a list of data objects stored in said at least one data store; and
the field specification for the data object attribute referencing the list of data objects further comprises a schema path property specifying, at least:
a type of data object in the list of data objects;
a first attribute of each data object in the list of data objects;
a second attribute of the data object corresponding to the data store object component containing the field specification; and
a relationship between the first attribute and the second attribute.

11. The computerized system of claim 10, wherein the schema path property specifies:
more than one type of data object; and
at least one relationship between attributes of each data object.

12. The computerized system of claim 9, further comprising a data store object source code generator configured to generate object-oriented programming language source code for each data store object component of the object-oriented heterogeneous data store interface.

13. A computer-readable medium having thereon computer-executable instructions for performing a method comprising:
instantiating a first query component of an object-oriented heterogeneous data store interface, each query component of the object-oriented heterogeneous data store interface having an add expression behavior, the add expression behavior having:
at least one query term parameter; and
a query operator parameter;
adding a query expression to the first query component with the add expression behavior of the first query component; and
providing the first query component to a data store component of the object-oriented heterogeneous data store interface.

14. The computer-readable medium of claim 13, wherein:
each query component further has:
a query conjunction behavior;
a begin group behavior; and
an end group behavior; and
the method further comprises:
adding a query conjunction to the first query component with the add conjunction behavior of the first query component;
adding a begin group to the first query component with the begin group behavior of the first query component; and
adding an end group to the first query component with the end group behavior of the first query component.

15. The computer-readable medium of claim 13, wherein:
each query component specifies a subset of enterprise data objects;
each query component further has:
a get extensible markup language (XML) behavior; and
a set from extensible markup language (XML) behavior; and
the method further comprises obtaining an extensible markup language (XML) representation of the subset of enterprise data objects specified by the first query component with the get extensible markup language (XML) behavior of the first query component.

16. The computer-readable medium of claim 13, wherein:
the method further comprises instantiating a second query component of the object-oriented heterogeneous data store interface; and
the query expression added to the first query component comprises the second query component.

17. The computer-readable medium of claim 16, wherein:
each query component specifies a subset of enterprise data objects; and
the query expression added to the first query component specifies a set of values, the set of values comprising values of a specified attribute of the subset of enterprise data objects specified by the second query component.

18. The computer-readable medium of claim 13, wherein:
one of a set of valid query operators is provided as the query operator parameter of the add expression behavior of each query component of the object-oriented heterogeneous data store interface; and
the set of valid query operators comprises:
an attribute contains (Contains) query operator that tests if a data object attribute specified by a first query term contains a value specified by a second query term;
a value within (Within) query operator that tests if a value specified by the first query term is within a set of values specified by at least one subsequent query term;
a Has query operator that tests if a data object specified by the first query term has at least one of a set of data objects specified by said at least one subsequent query term; and
a null test (IsNull) query operator that tests if the data object attribute specified by the first query term has a null value.

19. The computer-readable medium of claim 13, wherein:
each query component specifies a subset of enterprise data objects; and
the method further comprises receiving a set of data store object components of the object-oriented heterogeneous data store interface from the data store component as a result of providing the first query component to the data store component, each data store object component in the set of data store object components corresponding to an enterprise data object in the subset of enterprise data objects specified by the first query component.

20. The computer-readable medium of claim 19, wherein each data store object component comprises a field list attribute comprising a field specification for at least one data object attribute of the data object corresponding to the data store object component, the field specification comprising a defer property specifying that retrieval of the data object attribute is deferrable.

21. The computer-readable medium of claim 20, wherein:
said at least one data object attribute comprises a data object attribute referencing a list of data objects stored in at least one data store; and
the field specification for the data object attribute referencing the list of data objects further comprises a schema path property specifying, at least:
a type of data object in the list of data objects;
a first attribute of each data object in the list of data objects;
a second attribute of the data object corresponding to the data store object component containing the field specification; and
a relationship between the first attribute and the second attribute.

22. The computer-readable medium of claim 21, wherein the schema path property specifies:
more than one type of data object; and
at least one relationship between attributes of each data object.

23. A computerized system, comprising:
at least one data store of at least one data store type, each data store capable of storing at least one data object;
an object-oriented heterogeneous data store interface comprising at least one data store object component corresponding to at least one of said at least one data object stored in said at least one data store;
a data store object design graphical user interface configured to enable building of a graphical representation of each data object corresponding to data store object components of the object-oriented heterogeneous data store interface; and
a data store object source code generator capable of generating object-oriented programming language source code for each data store object component of the object-oriented heterogeneous data store interface.

24. The computerized system of claim 23, further comprising an extensible markup language (XML) data store object definition generator configured to generate an extensible markup language (XML) data store object definition from the graphical representation in accordance with an extensible markup language (XML) data store object definition schema.

25. The computerized system of claim 24, wherein the data store object source code generator generates object-oriented programming language source code for each data store object component corresponding to the extensible markup language (XML) data store object definition generated from the graphical representation.

26. The computerized system of claim 24, wherein the extensible markup language (XML) data store object definition comprises at least one data store object definition element containing at least one data store object attribute definition element, and each data store object attribute definition element includes a defer property specifying that retrieval of the data object attribute is deferrable.

27. The computerized system of claim 26, wherein:
at least one of said at least one data store object attribute definition element defines a data object attribute referencing a list of data objects stored in said at least one data store; and
each data store object attribute definition element that defines the data object attribute referencing the list of data objects further includes a schema path property specifying, at least:
a type of data object in the list of data objects;
a first attribute of each data object in the list of data objects;
a second attribute of the data object corresponding to the data store object definition element containing the data store object attribute definition element; and
a relationship between the first attribute and the second attribute.

28. The computerized system of claim 27, wherein the schema path property specifies:
more than one type of data object; and
at least one relationship between attributes of each data object.

29. The computerized system of claim 23:
wherein the object-oriented heterogeneous data store interface further comprises:
a query component; and
a provider interface comprising a query component behavior specification specifying a query behavior with a query component parameter; and
further comprising, for each type of data store, a provider plug-in to the object-oriented heterogeneous data store interface, each provider plug-in comprising at least one provider component configured with a query behavior conforming to the query component behavior specification of the provider interface.

30. The computerized system of claim 29, further comprising, for at least one provider plug-in, a corresponding data store object source code generator plug-in capable of generating data objects for the type of data store associated with the provider plug-in.

31. The computerized system of claim 23, wherein the graphical representation of each data object comprises a security policy designation.
